(19) United States
(12) Patent Application Publication
(10) Pub. No.: US 2016/0062581 A1
(43) Pub. Date: Mar. 3, 2016

(54) METHOD AND DEVICE FOR DISPLAYING FILE

(71) Applicant: Xiaomi Inc., Beijing (CN)

(72) Inventors: Shen LI, Beijing (CN); Yuwen ZHANG, Beijing (CN); Jingwei CAI, Beijing (CN)

(73) Assignee: Xiaomi Inc., Beijing (CN)

(21) Appl. No.: 14/749,916

(22) Filed: Jun. 25, 2015

Related U.S. Application Data
(63) Continuation-in-part of application No. PCT/CN2015/071291, filed on Jan. 22, 2015.

(30) Foreign Application Priority Data
Aug. 27, 2014 (CN) 201410429471.4

(51) Int. Cl. G06F 3/0484; G06F 3/0481

(52) U.S. Cl. CPC G06F 3/0484; G06F 3/0481; G06F 2203/04806

(57) ABSTRACT

The present disclosure relates to methods and devices for displaying a document, which pertain to the field of computer technology. The method includes: in a state where a target document is displayed on a screen, when it is detected that the screen is subjected to displacement, determining a direction of the displacement; and translating the target document on the screen according to the direction of the displacement.

### PRIORITY STATEMENT

This application is a continuation-in-part of International Application No. PCT/CN2015/071291, filed Jan. 22, 2015, which is based upon and claims priority to Chinese Patent Application No. CN201410429471.4, filed Aug. 27, 2014, the entire contents of all of which are incorporated herein by reference.

### TECHNICAL FIELD

The present disclosure generally relates to the field of computer technology, and more particularly, to methods and devices for displaying a document.

### BACKGROUND

With development of the mobile terminal technology, mobile terminals have become more and more multifunctional, and have become one of the most indispensable tools in daily work and life. Users usually browse various types of information, such as, texts, pictures, videos and the like, on mobile terminals.

When a picture is displayed on a mobile terminal, often the actual size of the picture exceeds the display range of the screen of the mobile terminal, for example, in a case where a photo is taken by full-view photographing or a picture is displayed after being zoomed-in. When browsing such a picture on a mobile terminal with a touch screen, the user may perform a swipe operation to slide his/her fingers on the screen, such that the picture is translated on the screen. In this way, the user may browse different regions of the picture.

### SUMMARY

The present disclosure provides methods and devices for displaying a target document. When displaying the target document in a terminal device, a user of the terminal device may translate and/or move or zoom the image of the target document according to a movement of the terminal device to visually create an effect that the displayed target document remains stationary behind a screen of the terminal device and the user is observing the target document through a window of the screen size by moving over the target document.

According to an aspect of the present disclosure, a terminal device may comprise a screen; a processor-readable storage medium comprising a set of instructions for displaying a document; and a processor in communication with the storage medium. When displaying a target document on the screen, the processor may execute the set of instructions to, when a translation function of the terminal device is enabled, detect a displacement of the terminal device; determine a direction of the displacement; and translate the target document on the screen according to the direction of the displacement.

According to another aspect of the present disclosure, A method for displaying a document may comprises providing a terminal device to a user to display a target document on a screen thereof; when a translation function of the terminal device is enabled: detecting, by the terminal device, a displacement of the terminal device; determining, by the terminal device, a direction of the displacement; and translating, by the terminal device, the target document on the screen according to the direction of the displacement.

According to yet another aspect of the present disclosure, a non-transitory processor-readable storage medium may comprise a set of instructions for displaying a document. When executed by a processor, the set of instructions directs the processor to perform acts of: displaying a target document on a screen of a terminal device; when a translation function of the terminal device is enabled: detecting a displacement of the terminal device; determining a direction component of the displacement along a plane where the screen is located as a first direction; and translating the target document on the screen in a direction opposite to the first direction to generate a visual effect that the picture remains stationary and the user moves a window of the screen size over the picture.

### BRIEF DESCRIPTION OF THE DRAWINGS

The accompanying drawings, which are incorporated in and constitute a part of this specification, illustrate embodiments consistent with the invention and, together with the description, serve to explain the principles of the invention, in which:

FIG. 1a is a flowchart of a method for displaying a document according to an example embodiment of the present disclosure;

FIG. 1b is a flowchart of a method for displaying a target document according to an example embodiment of the present disclosure;

FIG. 1c illustrates a terminal device subject to a displacement;

FIG. 2 is a schematic diagram of a displayed interface on a screen of a terminal device according to an example embodiment of the present disclosure;

FIG. 3 is a schematic diagram of a displayed interface on a screen of a according to an example embodiment of the present disclosure;

FIG. 4 is a block diagram of a device for displaying a document according to an example embodiment of the present disclosure; and

FIG. 5 is a block diagram of a terminal device according to an example embodiment of the present disclosure.

The above drawings are used for illustrating the embodiments of the present disclosure given hereinafter, and more details will be given hereinafter. These drawings and textual descriptions are not intended to limit the scope defined in the present disclosure in any way, but intended to describe the inventive concept of the present disclosure, through specific embodiments, for a person skilled in the art.

### DETAILED DESCRIPTION

When a user is browsing a picture larger than the screen of his/her mobile terminal, the user may have to slide over the screen with his/her fingers in order to browse different regions of the picture. This browsing method is cumbersome. The present disclosure provides improved methods and devices that adapt a new technology for displaying documents such as large pictures. The new technology enables the device, such as a mobile terminal, to obtain new functions for document display. With the new functions, the user may browse the document such as a large image more conveniently.

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of devices and methods consistent with aspects related to the invention as recited in the appended claims.

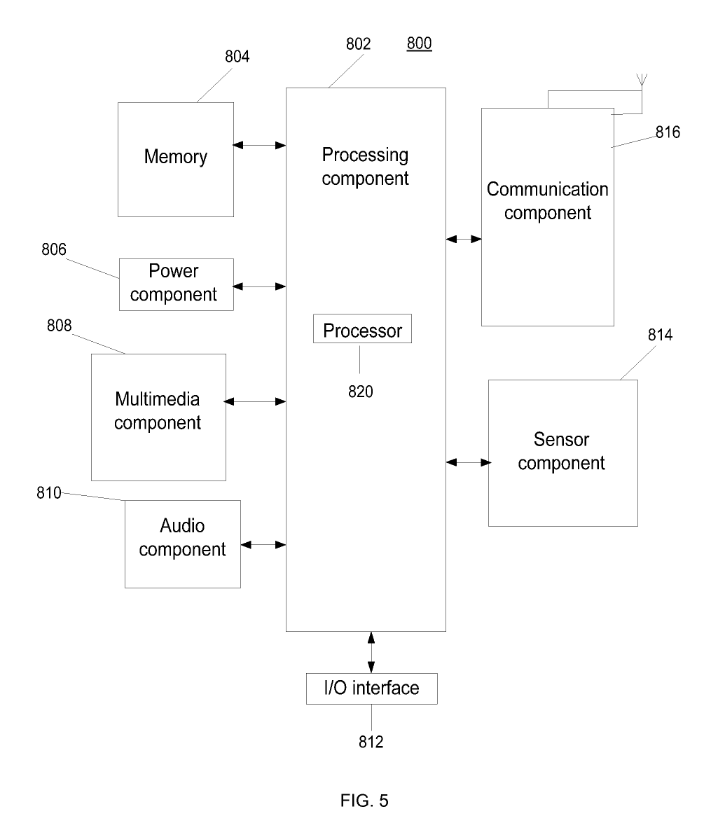

FIG. 5 is a block diagram of a device 800 according to an example embodiment of the present disclosure. The terminal device 800 may be a mobile phone or the like.

The device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer readable storage medium including instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

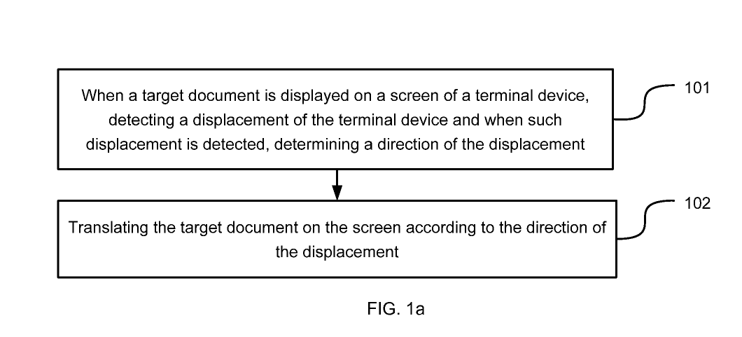

FIG. 1a is a flowchart of a method for displaying a document according to an example embodiment of the present disclosure. The method may be implemented in a terminal device such as the device 800. For example, the method may be implemented as a set of instructions stored in the memory 804 of the device 800 and may be executed by the processor 820 of the device 800. The method may include the following steps:

In step 101, when a target document is displayed on a screen of a terminal device, detecting a displacement of the terminal device and when such displacement is detected, determining a direction of the displacement.

In step 102, translating the target document on the screen according to the direction of the displacement.

According to embodiments of the present disclosure, in a state where a target document is displayed on its screen, when the terminal device detects that the screen is subjected to displacement, the terminal may determine a direction of the displacement, and translate (i.e., move) the target document on the screen according to the direction of the displacement. In this way, terminal device may display different regions of the target document on the screen when its user moves the mobile terminal device around.

FIG. 1b is a flowchart of a method for displaying a target document according to an example embodiment of the present disclosure. The method may be implemented in a terminal device such as the device 800. The device 800 may be a mobile phone, a tablet computer, or other mobile terminals. For example, the method may be implemented as a set of instructions stored in the memory 804 of the device 800 and may be executed by the processor 820 of the device 800. The target document may be a document saved in the terminal device or downloaded from a remote server, comprising displayable content, such as a picture, a POWERPOINT™ document, or other type of document, or the like. For illustration purpose, in this embodiment, the terminal device is described as a mobile phone and the target document is described as a picture. The method may include the following steps:

In step 101, when a target document is displayed on a screen of a terminal device, detecting a displacement of the terminal device and when such displacement is detected, determining a direction of the displacement.

In the embodiment, the size of the target document may exceed the size of the screen. For example, the target document may be a photo that is taken by full-view photographing or a photo or document displayed after being zoomed in.

In implementation, a user may install an application program for browsing pictures on the terminal device. When the user needs to browse a picture (i.e., the target document), the user may start the application program, and click an icon corresponding to the picture in a picture list provided by the application program, such that the picture is displayed on the screen of the terminal device. The size of the picture may be greater than the size of the screen. In this way, only a part of the picture may be displayed on the screen. When the user desires to view other parts of the picture which is not displayed on the screen, the user may do so by moving the terminal device. In this case, the terminal device may detect a signal sent by a corresponding sensor (for example, a gyroscope, an acceleration sensor, or the like) therein, and thus determine that the terminal device is subjected to a displacement. In this way, the terminal device may further determine the direction of the displacement. For example, when the user opens a full-view photograph on the terminal device, and in browsing the full-view photograph, the user moves the terminal device to the right, then the terminal device may detect that it is subjected to a displacement, and may further determine that the direction of the displacement is towards the right.

According to an example embodiment, the terminal device may only determine a direction of a component of the displacement along a plane where the screen is located; and correspondingly the process in step 101 may further include step 104: when the target document is displayed on a screen of a terminal device, detecting a displacement of the terminal device. When such displacement is detected, determining a direction of a component of the displacement along a plane where the screen of the terminal device is located as a first direction.

In implementation, instead of moving the terminal device exactly within the plane where the screen is located, the user may move the terminal device in any direction, for example, moving the terminal device towards the upper right direction of the screen. Upon detecting that the terminal device is subjected to the displacement, the terminal device may determine, according to a signal from the sensor, the direction of the component of the displacement along the plane where the screen is located. For example, in a case where the user holds and moves the terminal device to the upper right direction of the screen, upon detecting that the terminal device is subjected to displacement, the terminal device may determine that the direction of the component of the displacement along the plane where the screen is located is a direction towards the right. For example, as shown in FIG. 1c, in a 3-dimensional space defined by x-y-z axis, the screen of the terminal device 202 may be in the x-y plan, which mathematically is expressed by a vector i along the z axis. The user of the terminal device may move the terminal device with a displacement of d 45 degree towards up right direction within the x-z plane. The terminal device may detect the displacement and determine that the displacement has a vector component d1 pointing towards right along the x axis.

According to an example embodiment, the terminal device may also acquire a distance of the component of the displacement along the plane from where the screen is located; and correspondingly the process in step 101 may further include step 106: when the target document is displayed on a screen of a terminal device, detecting a displacement of the terminal device. When such displacement is detected, determining a direction of a component of the displacement along a plane where the screen is located as a first direction and determining a distance of the component of the displacement along the plane where the screen is located (e.g., determining a distance along) as a first distance.

In implementation, upon detecting that the terminal device is subjected to displacement, the terminal device may determine the direction of the component of the displacement along the plane where the screen is located and determine the distance of the component of the displacement along the plane where the screen is located. For example, as shown in FIG. 1c, when the user holds the terminal device and moves it by d=1.414 cm and 45 degree to the upper right direction of the screen, upon detecting that the terminal device is subjected to displacement, the terminal device may determine that the direction of the component of the displacement along the plane where the screen is located is a direction towards the right, and the distance of the component of the displacement along the plane where the screen is located is d1=d×cos(45°)=1 cm.

According to an example embodiment, before it is detected that the terminal device is subjected to displacement, the terminal device may enable a sensor configured to detect displacement of the terminal device when displaying an image having a large size; and correspondingly, prior to step 101, the terminal device may perform step 108: when the terminal device detects a full size of the target document displayed on the screen exceeds a size of the screen, enabling a sensor configured to detect displacement of the screen.

In implementation, when the terminal device detects that a picture is displayed on the screen thereof, the terminal device may detect the size of the picture, and compare the size of the picture with the size of the screen. If the size of the picture is greater than the size of the screen, the terminal device may enable the sensor (for example, a gyroscope, an acceleration sensor, or the like), to detect information regarding the displacement of the terminal device. If the size of the picture is less than the size of the screen, the terminal device keeps the sensor disabled. For example, when the user opens a picture on the terminal device, the terminal device displays the picture in a default size, and when the terminal device detects that the default size of the picture does not exceed the size of the screen, the terminal device does not enable the sensor. If the user zooms in the displayed picture, the terminal device may detect the size of the zoomed-in picture. When the terminal device detects that the size of the picture exceeds the size of the screen, the terminal device may enable the sensor. In this way, power consumption of the terminal device may be reduced.

According to an example embodiment, the terminal device may provide a plurality of display control functions to its user, for example, a document translation function and a document zooming function. Hence, the terminal device may perform the process in this procedure only in a state where the document translation function is enabled. Correspondingly, step 101 may subject to a precondition, such as enabling a translation function of the terminal device. For example, step 104 may further include: when the target document is displayed on a screen of a terminal device and the document translation function is enabled, when the target document is displayed on a screen of a terminal device, detecting a displacement of the terminal device. When such displacement is detected, determining a direction of a component of the displacement along a plane where the screen of the terminal device is located as a first direction.

In implementation, in the above application program, both the document translation function and the document zooming function may be enabled, and manners for enabling these two functions may be provided. For example, the document zooming function may be set as enabled when a touch signal is generated on the screen, and correspondingly, the document translation function may be enabled when no touch signal is generated on the screen. When the user desires to translate the picture, the user may keep his or her finger away from touching the screen. In this way, the terminal device detects no touch signal on the screen, and thus enables the document translation function. When the user holds the terminal device and moves it, the terminal device may determine the direction of the component of the displacement along the plane where the screen is located upon detecting that the terminal device is subjected to displacement. For example, if the user does not contact the screen, the terminal device detects no touch signal on the corresponding screen, and thus enables the document translation function; and when the user holds the terminal device and moves it towards the upper right direction, the terminal device may determine that the direction of the component of the displacement along the plane where the screen is located is a direction towards the right.

The user may also use other means to enable the displacement detection function in terminal device. For example, the terminal device may provide a physical hotkey or button or a virtual hotkey or button on the screen. When the user presses the button, the terminal device may enable the sensor to detect the displacement as described above.

In step 102, the target document is translated on the screen according to the direction of the displacement.

For example, upon determining the direction of the displacement, the terminal device may translate the picture on the screen in a direction opposite to the direction of the displacement according to a preset displacement speed, and cease translating the picture on the screen when the terminal device detects that the displacement of the screen ceases.

According to an example embodiment, when the direction of the component of the displacement along the plane where the screen is located is determined as the first direction, the process in step 102 may include step 112: translating the target document on the screen in a direction opposite to the first direction.

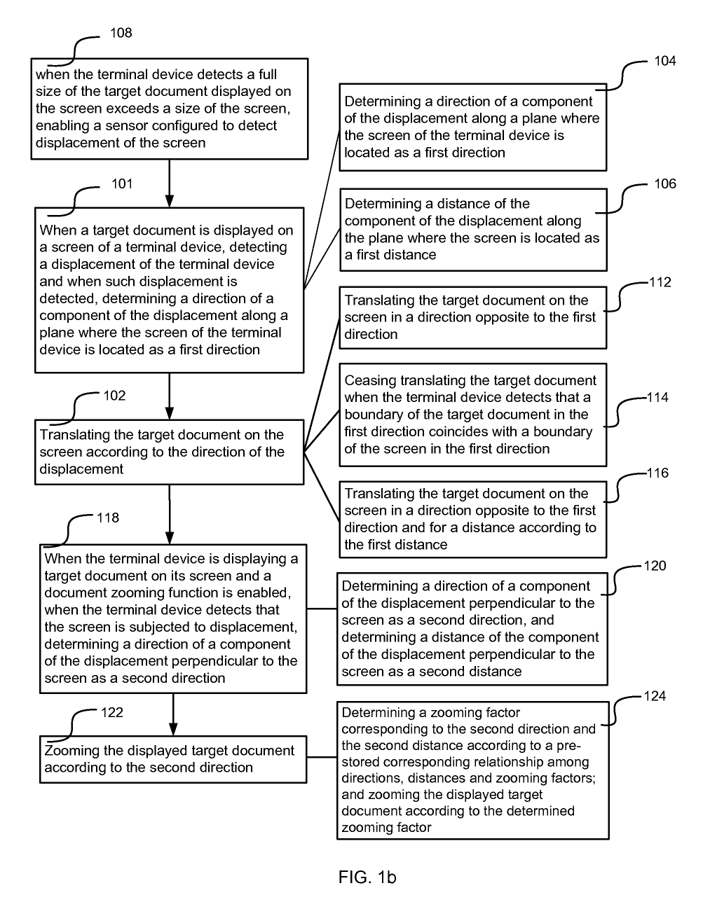

For example, upon determining the direction of the component of the displacement along the plane where the screen is located as the first direction, the terminal device may translate the picture on the screen in a direction opposite to the first direction. For example, as illustrated in FIG. 2, upon determining that the direction of the component d1 of the displacement along the x-y plane where the screen is located is a direction towards the right along the x axis, the terminal device translates the picture on the screen to the left to generate a visual effect that the picture remains stationary and the user is observing the target document through a window of the screen size by moving the window over the picture at certain speed.

According to an example embodiment, a condition for ceasing the translation may be defined; and correspondingly, the process in step 102 may include step 114: when the terminal device detects that a boundary of the target document in the first direction coincides with a boundary of the screen in the first direction, ceasing translating the target document.

For example, upon determining the direction of the component of the displacement along the plane where the screen is located as the first direction, the terminal device may translate the picture on the screen in a direction opposite to the first direction, until the boundary of the picture in the first direction coincides with the boundary of the screen in the first direction. For example, if the direction of the component of the displacement along the plane where the screen is located is determined as a direction towards the right, the terminal device translates the picture on the screen to the left, until the right boundary of the picture coincides with the right boundary of the screen.

According to an example embodiment, in a case where the distance of the component of the displacement along the first direction as the first distance; and correspondingly, the process in step 102 may include 116: translating the target document on the screen in a direction opposite to the first direction and for a distance according to the first distance.

For example, the terminal device may be preset with a linear relationship (for example, the translation distance is 1.5 or 2 times of the first distance, or the like) between the translation distance of the picture and the first distance. Upon determining the direction of the component of the displacement along the plane where the screen is located as the first direction and determining the distance of the component of the displacement along the plane where the screen is located as the first distance, the terminal device translates the picture in a direction opposite to the first direction, and the translation distance is a distance of the first distance subjected to a linear transformation. For example, if a linear relationship between the translation distance and the first distance is 2:1, upon determining that the direction of the component of the displacement along the plane where the screen is located is a direction towards the right, and the distance of the component of the displacement along the plane where the screen is located is 1 cm, the terminal device translates the picture displayed on the screen to the left by 2 cm.

In the embodiment, corresponding to the document translation function, the terminal device may also provide a document zooming function; and correspondingly, in a state where the document zooming function is enabled, the terminal device may perform the following steps.

In step 118, when the terminal device is displaying a target document on its screen and a document zooming function is enabled, when the terminal device detects that the screen is subjected to displacement, determining a direction of a component of the displacement perpendicular to the screen as a second direction.

For example, in the above application program, both the document translation function and the document zooming function may be provided, and manners for enabling these two functions may be provided. For example, the target zooming function may be set as enabled when a touch signal is generated on the screen, and correspondingly the document translation function may be set as enabled when no touch signal is generated on the screen. The user may also use other means to enable the displacement detection function in terminal device. For example, the terminal device may provide a physical hotkey or button or a virtual hotkey or button on the screen. When the user presses the button, the terminal device may enable the sensor to detect the displacement.

When the user desires to zoom in or zoom out the picture, the user may touch the screen with his or her finger. In this way, the terminal device may detect a touch signal on the screen, and thus enable the document zooming function. When the user holds the terminal device and moves it, the terminal device may determine the direction of the component of the displacement perpendicular to the screen upon detecting that the terminal device is subjected to displacement. For example, as shown in FIG. 1c, when the user touches the screen with his or her finger, the terminal device may detect a touch signal on the corresponding screen, and then enables the document zooming function; when the user holds the terminal device and moves it towards the upper right direction of the screen with a displacement vector d, the terminal device may determine that the direction of the component d2 of the displacement perpendicular to the screen is a forward direction of the screen upon detecting that the terminal device is subjected to displacement d.

According to an example embodiment, the terminal device may determine how to zoom the picture with reference to the direction and distance of the component of the displacement perpendicular to the screen; and correspondingly, the process in step 118 may include step 120: in a state where a target document is displayed on the screen and the document zooming function is enabled, when it is detected that the screen is subjected to displacement, determining a direction of a component of the displacement perpendicular to the screen as a second direction, and determining a distance of the component of the displacement perpendicular to the screen as a second distance.

For example, in a state where the document zooming function is enabled, upon detecting that the terminal device is subjected to displacement, the terminal device may determine the direction (i.e., the second direction) of the component of the displacement perpendicular to the screen, and the distance of the component of the displacement perpendicular to the screen (i.e., the second distance). For example, as shown in FIG. 1c when the user holds the terminal device and moves it by 1.414 cm and 45 degree to the upper right direction of the screen, upon detecting that the terminal device is subjected to displacement, the terminal device may determine that the direction of the component of the displacement perpendicular to the screen is a forward direction of the screen, and the distance of the component of the displacement perpendicular screen is d1=d×sin(45°)=1 cm.

In step 122, the displayed target document is zoomed according to the second direction.

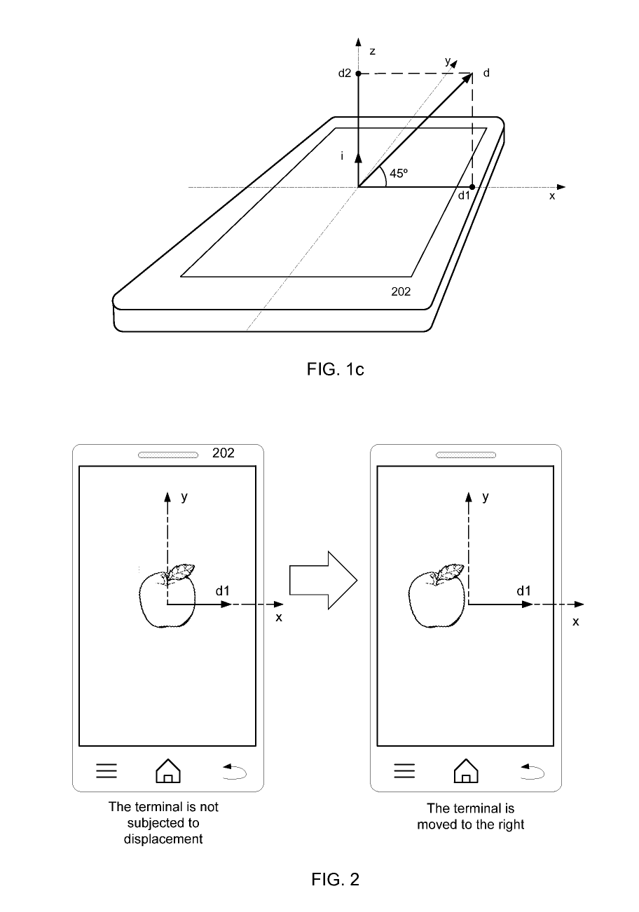

For example, the terminal device may preset a zooming factor for the zooming process; and in a state where the document zooming function is enabled, upon determining the direction of the component of the displacement perpendicular to the screen as the second direction, the terminal device zooms in or zooms out the picture according to the preset zooming factor, as illustrated in FIG. 3. For example, if the terminal device presets a zooming factor of the size of the zoomed-in picture to the size of the original picture as 3:1, and presets a zooming factor of the size of the zoomed-out picture to the size of the original picture as 1:4, the terminal device may zoom in or zoom out the picture according to the preset zooming factor.

According to an example embodiment, in a case where the direction of the component of the displacement perpendicular to the screen is determined as the second direction, the terminal device may define a corresponding relationship between the second direction and the zooming process; and correspondingly, the process in step 2 may be: zooming in the target document if the second direction is a forward direction (or upward direction) of the screen, and zooming out the target document if the second direction is a backward direction (or downward direction) of the screen.

According to an example embodiment, in a case where the distance of the component of the displacement perpendicular to the screen is determined as the second distance, the process in step 122 may include step 124: determining a zooming factor corresponding to the second direction and the second distance according to a pre-stored corresponding relationship among directions, distances and zooming factors; and zooming the displayed target document according to the determined zooming factor.

For example, the terminal device may preset a corresponding relationship among directions, distances and zooming factors. In the corresponding relationship, if the direction of the component of the displacement perpendicular to the screen is the forward direction of the screen, the distance and the zooming factor are of a first linear relationship. For example, the first linear relationship may be that a zoom-in factor is increased by 0.5 each time the distance of the component of the displacement perpendicular to the screen is increased by 1 cm. In the corresponding relationship, if the direction of the component of the displacement perpendicular to the screen is the backward direction of the screen, the distance and the zooming factor are of a second linear relationship. For example, the second linear relationship may be that a zoom-out factor is reduced by 0.01 each time the distance of the component of the displacement perpendicular to the screen is increased by 1 cm.

Upon determining that the direction of the component of the displacement perpendicular to the screen as the second direction, and determining that the distance of the component of the displacement perpendicular to the screen as the second distance, the terminal device may determine a linear relationship (the first linear relationship or the second linear relationship) corresponding to the second direction, and hence further determine a zooming factor according to the second distance and the corresponding linear relationship thereof. For example, upon determining that the direction of the component of the displacement perpendicular to the screen is the forward direction of the screen, the terminal device may determine that a linear relationship corresponding to the direction is the first linear relationship. In this case, if the distance of the component of the displacement perpendicular to the screen is 1 cm, the zoom-in factor is 1.5; and if the distance of the component of the displacement perpendicular to the screen is 2 cm, the zoom-in factor is 2. Upon determining that the direction of the component of the displacement perpendicular to the screen is the backward direction of the screen, the terminal device may determine that a linear relationship corresponding to the direction is the second linear relationship. In this case, if the distance of the component of the displacement perpendicular to the screen is 1 cm, the zoom-out factor is 0.99; and if the distance of the component of the displacement perpendicular to the screen is 2 cm, the zoom-out factor is 0.98.

Accordingly, the combination of the displacement and the zooming creates a visual effect that the displayed target document remains stationary behind a screen of the terminal device and the user is observing the target document through a window of the screen size by moving forward and/or backward.

According to embodiments of the present disclosure, in a state where a target document is displayed on a screen, when it is detected that the screen is subjected to displacement, a direction of the displacement is determined, and the target document is translated on the screen according to the direction of the displacement. In this way, different regions of the target document may be displayed on the screen by moving the terminal device.

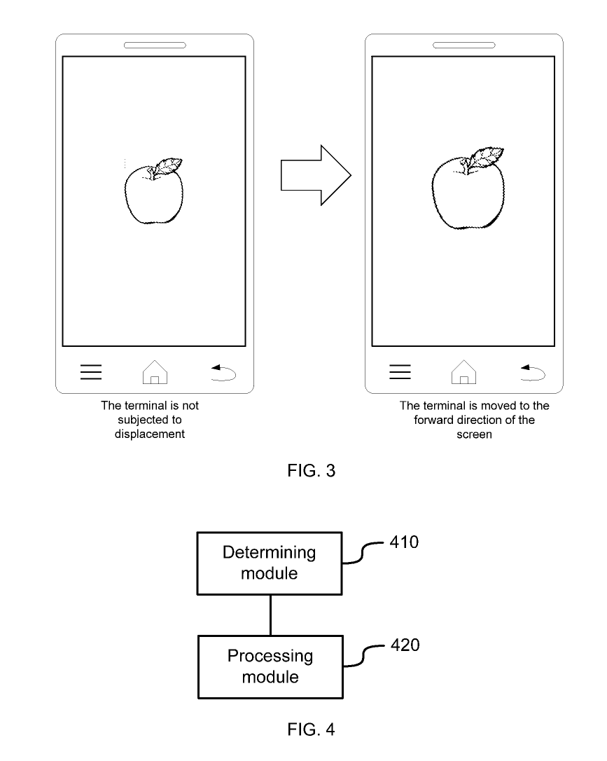

FIG. 4 is a block diagram of a device for displaying a document according to an example embodiment of the present disclosure. The device may be a terminal device such as the device 800. The device may be a mobile phone, a tablet computer, or other mobile terminals. The device may include a determining module 410 and a processing module 420.

The determining module 410 is configured to: in a state where a target document is displayed on a screen, when it is detected that the screen is subjected to displacement, determine a direction of the displacement. The processing module 420 is configured to translate the target document on the screen according to the direction of the displacement.

According to an example embodiment, the determining module 410 is configured to: in a state where a target document is displayed on a screen, when it is detected that the screen is subjected to displacement, determine a direction of a component of the displacement along a plane where the screen is located as a first direction. The processing module 420 is configured to: translate the target document on the screen in a direction opposite to the first direction.

According to an example embodiment, the processing module 420 is configured to: when it is detected that a boundary of the target document in the first direction coincides with a boundary of the screen in the first direction, cease translating the target document.

According to an example embodiment, the determining module 410 is configured to: in a state where a target document is displayed on a screen, when it is detected that the screen is subjected to displacement, determine a direction of a component of the displacement along a plane where the screen is located as a first direction, and determine a distance of the component of the displacement along the plane where the screen is located as a first distance. The processing module 420 is configured to: translate the target document on the screen in a direction opposite to the first direction according to the first distance.

According to an example embodiment, the determining module 410 is configured to: in a state where a target document is displayed on a screen and a document translation function is enabled, when it is detected that the screen is subjected to displacement, determine a direction of a component of the displacement along a plane where the screen is located as a first direction. The determining module 410 is further configured to: in a state where a target document is displayed on a screen and a document zooming function is enabled, when it is detected that the screen is subjected to displacement, determine a direction of a component of the displacement perpendicular to the screen as a second direction. The processing module 420 is configured to: zoom the displayed target document according to the second direction.

According to an example embodiment, the determining module 410 is configured to: in a state where a target document is displayed on a screen and a document zooming function is enabled, when it is detected that the screen is subjected to displacement, determine a direction of a component of the displacement perpendicular to the screen as a second direction, and determine a component of the displacement perpendicular to the screen as a second distance. The processing module 420 is configured to: determine a zooming factor corresponding to the second direction and the second distance according to a pre-stored corresponding relationship among directions, distances and zooming factors; and zoom the displayed target document according to the determined zooming factor.

According to an example embodiment, the processing module 420 is configured to: zoom in the target document if the second direction is a forward direction of the screen; and zoom out the target document if the second direction is a backward direction of the screen.

According to an example embodiment, the device further includes: an enabling module, configured to: when it is detected that a full size of the target document displayed on the screen exceeds a size of the screen, enable a sensor configured to detect displacement of the screen.

According to embodiments of the present disclosure, in a state where a target document is displayed on a screen, when it is detected that the screen is subjected to displacement, a direction of the displacement is determined, and the target document is translated on the screen according to the direction of the displacement. In this way, different regions of the target document may be displayed on the screen by moving the terminal device.

With respect to the devices in the above embodiment, the specific implementations of operations executed by various modules thereof have been in detail described in the embodiments illustrating the methods, which are not described herein any further.

It should be noted that, during displaying of a picture by the devices for displaying a document according to the above embodiments, the devices are described by only using division of the above functional modules as examples. In practice, the functions may be assigned to different functional modules for implementation as required. To be specific, the internal structure of the device is divided into different functional modules to implement all or part of the above-described functions. In addition, the devices for displaying a document according to the above embodiments are based on the same inventive concept as the methods for displaying a document according to the embodiments of the present disclosure. The specific implementation is elaborated in the method embodiments, which is not described herein any further.

According to an example embodiment, a non-transitory computer-readable storage medium. For example, the storage medium may be a storage medium of the device 800. The storage medium may include a set of instructions stored. When the set of instructions is executed by a processor of a terminal device, such as the device 800, the set of instructions may direct the terminal device to perform actions implementing a method for displaying a document. The actions may include:

In a state where a target document is displayed on a screen, when it is detected that the screen is subjected to displacement, determining a direction of the displacement; and translating the target document on the screen according to the direction of the displacement.

According to an example embodiment, the actions may further include: in a state where a target document is displayed on a screen, when it is detected that the screen is subjected to displacement, determining a direction of the displacement includes: in a state where a target document is displayed on a screen, when it is detected that the screen is subjected to displacement, determining a direction of a component of the displacement along a plane where the screen is located as a first direction.

The translating of the target document on the screen according to the direction of the displacement includes: translating the target document on the screen in a direction opposite to the first direction.

According to an example embodiment, the actions may further include: when it is detected that a boundary of the target document in the first direction coincides with a boundary of the screen in the first direction, ceasing translating the target document.

According to an example embodiment, the actions may include: in a state where a target document is displayed on a screen, when it is detected that the screen is subjected to displacement, determining a direction of a component of the displacement along a plane where the screen is located as a first direction includes: in a state where a target document is displayed on a screen, when it is detected that the screen is subjected to displacement, determining a direction of a component of the displacement along a plane where the screen is located as a first direction, and determining a distance of the component of the displacement along the plane where the screen is located as a first distance.

The translating of the target document on the screen in a direction opposite to the first direction includes: translating the target document on the screen in a direction opposite to the first direction according to the first distance.

According to an example embodiment, the actions may include: in a state where a target document is displayed on a screen, when it is detected that the screen is subjected to displacement, determining a direction of a component of the displacement along a plane where the screen is located as a first direction includes: in a state where a target document is displayed on a screen and a document translation function is enabled, when it is detected that the screen is subjected to displacement, determining a direction of a component of the displacement along a plane where the screen is located as a first direction;

The actions may further include: in a state where a target document is displayed on a screen and a document zooming function is enabled, when it is detected that the screen is subjected to displacement, determining a direction of a component of the displacement perpendicular to the screen as a second direction; and zooming the displayed target document according to the second direction.

According to an example embodiment, the actions may include: in a state where a target document is displayed on a screen and a document zooming function is enabled, when it is detected that the screen is subjected to displacement, determining a direction of a component of the displacement perpendicular to the screen as a second direction includes: in a state where a target document is displayed on a screen and a document zooming function is enabled, when it is detected that the screen is subjected to displacement, determining a direction of a component of the displacement perpendicular to the screen as a second direction, and determining a distance of a component of the displacement perpendicular to the screen as a second distance.

Zooming the displayed target document according to the second direction includes: determining a zooming factor corresponding to the second direction and the second distance according to a pre-stored corresponding relationship among directions, distances and zooming factors; and zooming the displayed target document according to the determined zooming factor.

The zooming of the displayed target document according to the second direction includes: zooming in the target document if the second direction is a forward direction of the screen; and zooming out the target document if the second direction is a backward direction of the screen.

According to an example embodiment, the actions may include, in a state where a target document is displayed on a screen, when it is detected that the screen is subjected to displacement, before the determining a direction of the displacement, the method further includes:

when it is detected that a full size of the target document displayed on the screen exceeds a size of the screen, enabling a sensor for detecting displacement of the screen.

According to embodiments of the present disclosure, in a state where a target document is displayed on a screen, when it is detected that the screen is subjected to displacement, a direction of the displacement is determined, and the target document is translated on the screen according to the direction of the displacement. In this way, different regions of the target document may be displayed on the screen by moving the terminal device.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as example only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A terminal device, comprising:
a screen;
a processor-readable storage medium comprising a set of instructions for displaying a document; and
a processor in communication with the storage medium, wherein
when displaying a target document on the screen, the processor executes the set of instructions to, when a translation function of the terminal device is enabled,
detect a displacement of the terminal device;
determine a direction of the displacement; and
translate the target document on the screen according to the direction of the displacement.

2. The terminal device according to claim 1, wherein the processor further executes the set of instructions to determine a direction component of the displacement along a plane where the screen is located as a first direction,
wherein to translate the target document on the screen the processor further executes the set of instructions to translate the target document on the screen in a direction opposite to the first direction to generate a visual effect that the target document remains stationary and the user observes the target document through a window of the screen size by moving the window over the target document.

3. The terminal device according to claim 2, where the processor further executes the set of instructions to:
cease translating the target document when the processor detects that a boundary of the target document in the first direction coincides with a boundary of the screen in the first direction.

4. The terminal device according to claim 2, wherein the processor further executes the set of instructions to:
determine a distance component of the displacement along the first direction as a first distance; and
translate the target document on the screen for a distance according to the first distance.

5. The terminal device according to claim 1, wherein the processor further executes the set of instructions to, when a document zooming function of the terminal device is enabled,
determine a direction component of the displacement perpendicular to the screen as a second direction; and
zoom the displayed target document according to the second direction.

6. The terminal device according to claim 5, wherein the processor further executes the set of instructions to:
determine a distance component of the displacement along the second direction as a second distance; and
to zoom the displayed target document according to the second direction the processor further executes the set of instructions to:
determine a zooming factor corresponding to the second direction and the second distance; and
zoom the displayed target document according to the determined zooming factor.

7. The terminal device according to claim 5, wherein to zoom the displayed target document according to the second direction the processor further executes the set of instructions to:
zoom in the target document when the second direction is a forward direction of the screen; and
zoom out the target document when the second direction is a backward direction of the screen.

8. The terminal device according to claim 1, wherein the processor further executes the set of instructions to:
detect that a size of the target document displayed on the screen exceeds a size of the screen; and
enable a sensor of the terminal device to detect the displacement of the screen.

9. A method for displaying a document, comprising:
providing a terminal device to a user to display a target document on a screen thereof;
when a translation function of the terminal device is enabled:
detecting, by the terminal device, a displacement of the terminal device;
determining, by the terminal device, a direction of the displacement; and
translating, by the terminal device, the target document on the screen according to the direction of the displacement.

10. The method according to claim 9, further comprising determining, by the terminal device, a direction component of the displacement along a plane where the screen is located as a first direction,
wherein the translating of the target document on the screen comprises translating the target document on the screen in a direction opposite to the first direction to generate a visual effect that the target document remains stationary and the user observes the target document through a window of the screen size by moving the window over the target document.

11. The method according to claim 10, further comprising:
when the terminal device detects that a boundary of the target document in the first direction coincides with a boundary of the screen in the first direction, ceasing, by the terminal device, translating the target document.

12. The method according to claim 10, further comprising:
determining, by the terminal device, a distance component of the displacement along the first direction as a first distance; and
translating, by the terminal device, the target document on the screen for a distance according to the first distance.

13. The method according to claim 9, further comprising, when a document zooming function of the terminal device is enabled,
determining, by the terminal device, a direction component of the displacement perpendicular to the screen as a second direction; and
zooming, by the terminal device, the displayed target document according to the second direction.

14. The method according to claim 13, further comprising:
determining, by the terminal device, a distance component of the displacement along the second direction as a second distance; and
the zooming of the displayed target document according to the second direction comprises:
determining, by the terminal device, a zooming factor corresponding to the second direction and the second distance; and
zooming, by the terminal device, the displayed target document according to the determined zooming factor.

15. The method according to claim 13, wherein the zooming of the displayed target document according to the second direction comprises:
zooming in the target document when the second direction is a forward direction of the screen; and
zooming out the target document when the second direction is a backward direction of the screen.

16. The method according to claim 9, further comprising:
detecting, by the terminal device, that a size of the target document displayed on the screen exceeds a size of the screen; and
enabling, by the terminal device, a sensor of the terminal device to detect the displacement of the screen.

17. A non-transitory processor-readable storage medium, comprising a set of instructions for displaying a document, wherein when executed by a processor, the set of instructions directs the processor to perform acts of:
displaying a target document on a screen of a terminal device;
when a translation function of the terminal device is enabled:
detecting a displacement of the terminal device;
determining a direction component of the displacement along a plane where the screen is located as a first direction; and
translating the target document on the screen in a direction opposite to the first direction to generate a visual effect that the target document remains stationary and the user observes the target document through a window of the screen size by moving the window over the target document.

18. The storage medium according to claim 17, wherein the set of instructions further directs the processor to perform acts of:
determining a distance component of the displacement along the first direction as a first distance; and
translating the target document on the screen for a distance according to the first distance.

19. The storage medium according to claim 17, wherein the set of instructions further directs the processor to perform acts of, when a document zooming function of the terminal device is enabled,
determining a direction component of the displacement perpendicular to the screen as a second direction; and
zooming the displayed target document according to the second direction.

20. The storage medium according to claim 19, wherein the zooming of the displayed target document according to the second direction comprises:
zooming in the target document when the second direction is a forward direction of the screen; and
zooming out the target document when the second direction is a backward direction of the screen.
